(19) United States
(12) Patent Application Publication
(10) Pub. No.: US 2009/0171582 A1
(43) Pub. Date: Jul. 2, 2009

(54) VEHICLE NAVIGATION SYSTEM

(75) Inventors: Josef Stockinger, Karlsfeld (DE); Michael Blohm, Hannover (DE)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignees: STMicroelectronics Design and Application GmbH, Grassbrunn (DE); STMicroelectronics GmbH, Grassbrunn (DE)

(21) Appl. No.: 12/342,568

(22) Filed: Dec. 23, 2008

(30) Foreign Application Priority Data
Dec. 31, 2007 (EP) 07025242.4

(51) Int. Cl. G01C 21/30; G06F 3/048; G01C 25/00

(52) U.S. Cl. 701/211; 715/764; 702/97

(57) ABSTRACT

A vehicle navigation system may include an antenna, e.g. a GPS antenna, an output for providing guide advice to the vehicle driver and including a display, a memory encompassing a navigation database with electronic maps stored within, and an electronic controller. The system is capable of detecting the global position of the vehicle on the basis of the electromagnetic waves received by the antenna, associating the global position to the exact road position of the vehicle by comparison with the electronic maps and providing pictorial guide advice to the vehicle driver according to the road position via the display. The system may include a digital camera installed on the vehicle and able to record digital pictures of the outside and to provide the digital pictures to the electronic controller. The pictures are displayed via the display, and pictorial guide advice, e.g. directional arrows, are overprinted to the displayed pictures.

### FIELD OF THE INVENTION

The present invention generally relates to vehicle navigation systems and related methods. More in particularly, the present invention relates to Global Positioning Satellite (GPS) navigation systems and methods, for example.

### BACKGROUND OF THE INVENTION

Vehicle navigation systems may guide a vehicle driver by showing him/her maps and drive information or providing suggestions through an electronic display. Normally, traditional and known vehicle navigation systems of the GPS type rely on an antenna installed on or in the vehicle and capable of picking up electromagnetic waves transmitted from satellite sources, to define the exact position of the vehicle. The so defined position is compared with known geographical information by a microprocessor that is able to access a navigation database and associate the defined position of the vehicle with the corresponding street wherein the vehicle is driving.

Software is also provided to process information provided by the vehicle driver and to guide him/her from a starting location to an ending location as well as to supervise the route decided by the driver in real-time. Such navigation systems usually include an output device encompassing an electronic display and an automatic vocal reader notifying the driver of the actions to be taken. An example of a display use in this field is shown in FIG. 1, wherein the driving information is displayed in the form of a map MP with the addition of an arrow A, indicating the action to be taken, i.e. that the vehicle driver is supposed to turn right in some time to reach the indicated ending location, as calculated by the software of the navigation system connected to the display.

Future navigation systems will use stored three-dimensional maps and satellite recordings, e.g. Google Earth or TeleAtlas to give better guidance to the driver. A target of these navigation systems is to avoid confusion of the driver with pictorial maps, so that the vehicle driver does not have to understand and mentally transform the received information to the actual road situation. It is evident that a map such as the one shown in FIG. 1 is not so easy and immediate to be understood.

All recorded and stored maps also have another main problem, that due to construction or other circumstances (vegetation growing), the real road situation may have changed since the last recoding of such maps. So, the information displayed to the vehicle driver may not be updated and thus could be substantially unreadable or not understandable when compared with the real situation that the driver is watching.

### SUMMARY OF THE INVENTION

The issue underlying the present invention is to provide a system and a method for enhanced guiding of a vehicle driver with respect to the performance of the traditional navigation systems and methods.

In particular, an object of the invention includes providing more natural and understandable outputs for the vehicle driver.

The approach underlying the present invention is that of displaying a navigation direction indicator, as calculated by the navigator system, into a real scene captured by a vehicle camera. Such problem is addressed, according to the invention, by a system and method having the features discussed below.

For example, the vehicle navigation system may include an antenna, e.g. a GPS antenna, an output for providing guide advice to the vehicle driver and including a display, a memory encompassing a navigation database with electronic maps stored within, and an electronic controller. The system is capable of detecting the global position of the vehicle on the basis of the electromagnetic waves received by the antenna, associating the global position to the exact road position of the vehicle by comparison with the electronic maps and providing pictorial guide advice to the vehicle driver according to the road position via the display. The system may include a digital camera installed on the vehicle and able to record digital pictures of the outside and to provide the digital pictures to the electronic controller. The pictures are displayed via the display, and pictorial guide advice, e.g. directional arrows, are overprinted to the displayed pictures.

### BRIEF DESCRIPTION OF THE DRAWINGS

Further features and the advantages of the system and method of the invention will be appreciated by the following description of preferred embodiments provided here for illustrative and non-limiting purposes with reference to the enclosed figures.

FIG. 1 is a schematic representation of driving information as displayed according to a traditional or known navigation system.

FIG. 2A is a schematic diagram illustrating a vehicle including a navigation system according to the features of an embodiment of the present invention.

FIG. 2B is a schematic block diagram illustrating the components of the system of FIG. 2A.

FIG. 3 is a flow chart illustrating an embodiment of the method performed by the system of FIG. 2B.

FIG. 4 is a representation of a digital picture as recorded by a digital camera associated with the system of FIG. 2A.

FIG. 5 is a representation of the digital picture of FIG. 4 further including driving information, e.g. as display output of the system of FIG. 2A.

FIG. 6 shows a flow chart concerning a calibration process for a digital camera associated to the system according to the invention.

### DETAILED DESCRIPTION OF THE PREFERRED EMBODIMENTS

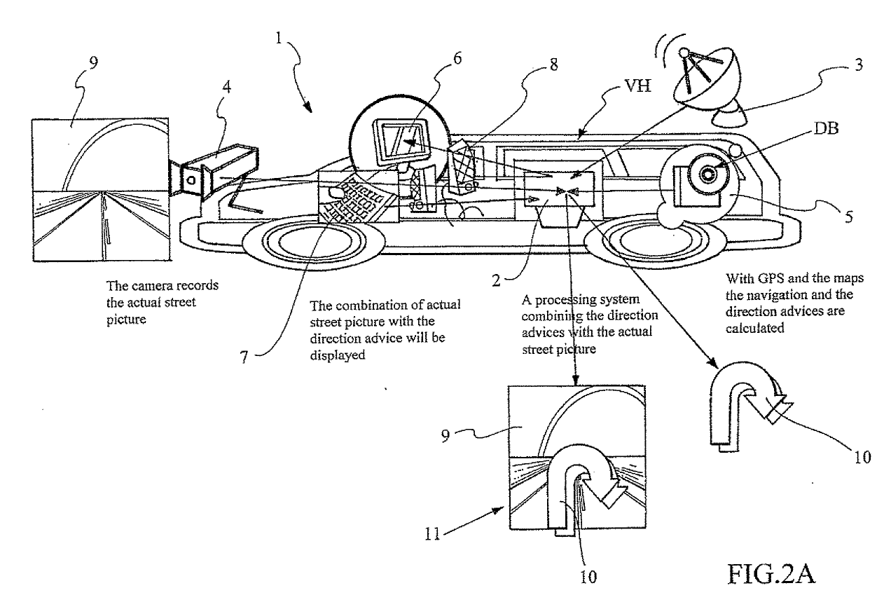

With particular reference to FIG. 2A and 2B, a vehicle navigation system 1 according to the present invention is schematically shown. The vehicle navigation system of the present invention may be incorporated or associated with a standard vehicle VH or car for providing the vehicle driver with pertinent guiding or driving information corresponding to a track or route that the vehicle driver needs to move along.

The vehicle navigation system 1 includes an electronic controller or processor unit 2, and a receiver or receiving means, in particular a Global Positioning System (GPS) or Global Navigation Satellite System (GNSS) antenna 3, connected to the electronic controller 2 (antennas compatible with other receiving standards might also be used). A camera 4 is connected to the electronic controller 2 structured for recording an actual situation or real scene in front of the vehicle VH equipped with the system 1. The camera 4 may be a digital camera, however the use of a standard analog camera is possible. The camera 4 is provided with a lens designed to catch the scene according to an angular point of view that corresponds to the vehicle driver's view.

A memory device 5 is accessible to the electronic controller 2 and has a navigation database DB (illustrated and discussed below in more detail) which includes the structure of the streets (e.g. structure of the streets, road signs and the layout of the lanes are). A display or displaying means, in particular an LCD monitor 6, is connected to the electronic controller 2 through a video interface.

A speaker, in particular a digital audio speaker 8, is connected to the electronic controller 2, and a user interface 7 or keyboard, is connected to the electronic controller 2, via which the user inputs commands and/or information. In particular, an user can edit, by using the keyboard or similar means of the user interface 7, an ending or final location to be reached and the system 1 shows the route to such an ending location from a starting location, as calculated by the electronic controller 2 starting from data obtained by the antenna 3.

According to a different embodiment of the present invention, the memory device 5 could be also internal or embedded into the electronic controller 2. The electronic controller 2, as will be more clearly explained in the following description, calculates in real-time a route to be followed by the vehicle VH, starting from an actual position thereof to reach the ending location, and provides a driving direction indicator, for instance in the form of an arrow 10.

Advantageously, according to the invention, the system 1 displays the driving direction indicator or arrow 10 onto the real scene 9 as captured by the digital camera 4 of the vehicle VH, thus forming a real scene based driving information 11. In this way, the driver will see exactly the same situation on his LCD monitor 6, that is seen looking out of the windscreen of the vehicle VH. The real scene 9 as captured by the digital camera 4, along with the arrow 10 added thereto, i.e. the real scene based driving information 11, may also be projected directly to the windscreen as a head-up display.

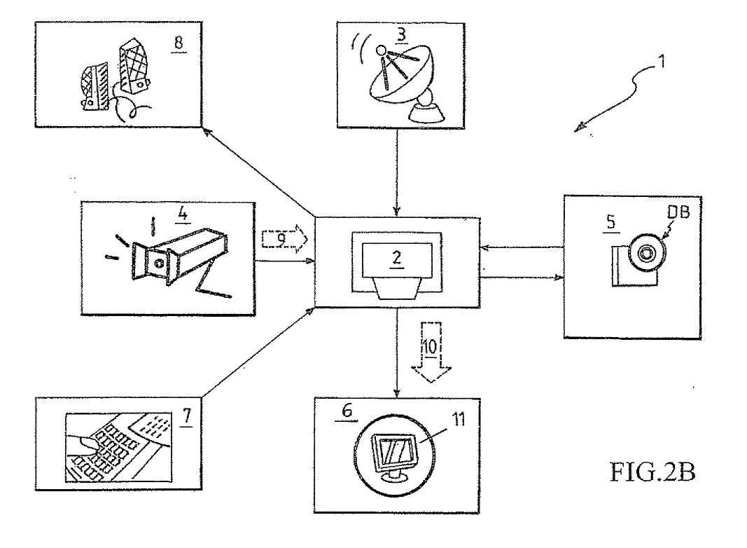

To provide the above explained driving information to the driver, the electronic controller 2, e.g. via an embedded microprocessor which is not illustrated in the figures, executes a series of process or method phases for providing a real scene based driving information 11 according to the present invention which is schematically illustrated in FIG. 3.

So, according to one embodiment, the present invention relates to a vehicle navigation system 1 including an antenna 3 structured to receive signals or electromagnetic waves transmitted by satellites, an electronic controller 2 or computer executing a software program 10 detecting the global position of the vehicle on the basis of the electromagnetic waves received by the antenna 3, and a memory 5 connected to the electronic controller 2 and containing a navigation database 16 including electronic maps. A display 6 is connected to outputs of the electronic controller 2 for presenting guide advice 10 to the vehicle driver according to the exact road position of the vehicle computed with reference to the electronic maps 5. A camera 4 is installed on the vehicle to provide on the display 6 an instant and live picture of the landscape view currently seen by the vehicle driver.

Advantageously, the camera 4 may be a digital camera and the guide advices include at least a directional arrow 10. Moreover, the live picture is stored in digital format inside a portion of the memory 5 and is refreshed in the memory portion 5 according to a time schedule of few micro-seconds.

A software program may be endowed with processes capable of recognizing lanes and lane limits in the digital pictures 9 and to display the arrow 10 within the lane limits. Also road barriers and other obstacles may be detected to force the system to recalculate the driving advices. The software program may further be able to process and compare the digital pictures 9 provided by the camera 4 with digital pictures pre-stored in the memory 5 and, in case of discrepancy, replacing the pre-stored digital pictures with the digital pictures provided by the camera. The digital pictures 9 may be processed and compared with the electronic maps 5 stored in the navigation database DB and, based upon a discrepancy, the electronic maps 5 are updated with updated road structure, e.g. lanes and lane limits. The processes are capable of recognizing road traffic signs and to update/adjust pictorial guide advices 10 according to the road traffic signs.

Referring now to a method provided by the present invention, such a method is provided for helping and guiding the vehicle driver through use of the navigation system 1. The method includes detecting a global positioning of the vehicle VH through an antenna 3 structured to receive electromagnetic waves transmitted by satellites and an electronic controller 2 of the navigation system, and comparing the global position with road maps pre-stored in a memory 5 of the system to define the road position of the vehicle with respect to the maps, with recording an instant and live picture of the landscape view currently seen by the vehicle driver by a camera 4 installed on the vehicle. The method includes displaying, e.g. on a display 11 of the system, the instant and live picture together with guide advices 10 for the vehicle driver according to the exact road position of the vehicle computed with reference to the maps. A digital camera is used for recording instant and live pictures.

More specifically, the method steps may include: S1—detecting a global positioning of the vehicle VH via the antenna 3, either according to the GPS or GNSS standard, and comparing this global position with pre-stored road maps (included into the navigation database DB of the memory device 5) to define a road position of the vehicle VH in one of such pre-stored road maps; S2—calculating in real-time a route to be followed by the vehicle VH on the basis of its actual road position and of an ending location as received by the user interface 7 and providing a navigation direction indicator; and S3—optionally calculating a distance D before a next direction change of the vehicle VH.

Advantageously according to the invention, the method may also include: S4—obtaining a picture from the digital camera 4 corresponding to the real scene 9 in front of the driver and storing such a picture in an appropriate format, or as an alternative, the picture may simply be transmitted as it is to the monitor 6 and presented to the user as a direct reproduction of the view in front of him/her; S5—processing the picture so that the streets lines, curbs and road structure are analyzed; S6—combining the analyzed road structure with the navigation direction indicator and with the calculated distance D; S7—calculating the driving direction indicator 10 in the form of a line or an arrow with respect to the real scene 9 comprising the actual street situation as captured by the digital camera 4; and S8—displaying on the LCD display 6 the combined real scene 9 with the line/arrow 10 as calculated, i.e. the real scene based driving information 11. In particular, the format of the pictures 9 could be, e.g. JPG, MPEG, DIVX, BMP, the pictures being stored in the memory device 5 or in a dedicated RAM memory as would be appreciated by those skilled in the art.

In another embodiment, the method according to the present invention may include: S9—analyzing and extracting the street lines, curb or road structure starting from the real scene 9; S10—analyzing and evaluating the road signs and available lanes for driving; and S11—comparing the structure of the street as evaluated by the step S10 (starting by the picture as taken by the digital camera 4) with a structure of the same street as stored in the Navigation database DB (in a preliminary phase, e.g. during the installation of the software program of the navigator system). In particular, the pictures as taken by the digital camera 4 are processed to detect lane limits (e.g. by the so called “mobile eye” systems).

Advantageously according to the invention, in case of a non-identical result of such comparison step S11, i.e. in case the real situation of a street does not correspond to the pre-stored one as reported in the Navigation database DB, the method may further include: S12—updating the Navigation database DB by recording the new structure of the street; and S13—recalculating the driving direction indicator 10 using the results (evaluated road signs and available lanes for driving) of step S10.

In this case, the optional step S3 of calculating a distance D before a next direction change of the vehicle VH will be based on the driving direction indicator 10 as recalculated in step S13. In such a way, in case a road has been blocked for driving momentarily or permanently, a new route to be driven is immediately calculated and the corresponding driving direction indicator 10 displayed to the user.

It should be noted that further improved software analyzing and evaluating approaches can future assist the driver, allowing for detection of road traffic signs like a one way road, road not allowed for driving and so on. In this case, even if the above explained step S12 of updating the Navigation database DB by recording the new structure of the street is not performed, the miss match between the stored situation and the captured one being due to momentarily legally usable roads (for instance, when a road is blocked by changed traffic signaling), a new driving direction indicator 10 is in any case calculated in step S13 and the alternative is displayed to the user to correctly drive him.

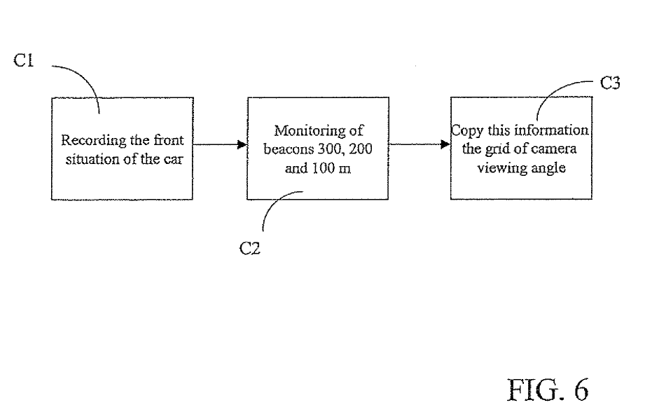

The method according to the invention may further include a calibration phase of the digital camera 4, which may comprise (with reference to FIG. 6): recording pictures of outside the vehicle (C1); monitoring beacons from different distances, e.g. 100 m, 200 m and 300 m (C2); and copying the information so obtained to the grid of the camera viewing angle to calibrate it (C3).

Detection can also be done based on metric information, for instance the beacons from distances may be given in miles or yards. The system for calibration is the same, only the indicators are provided with different value.

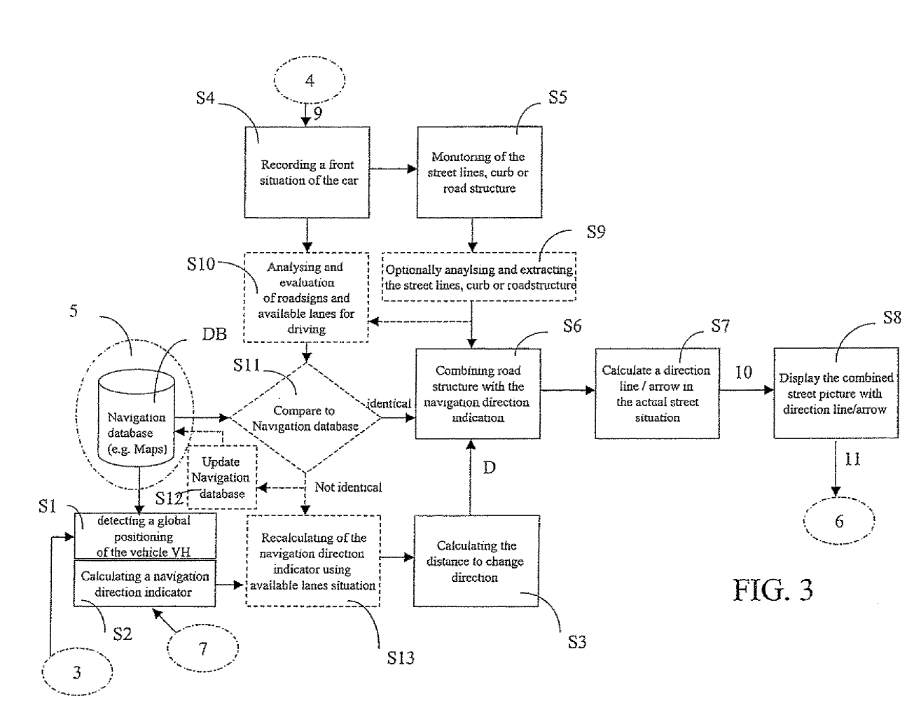

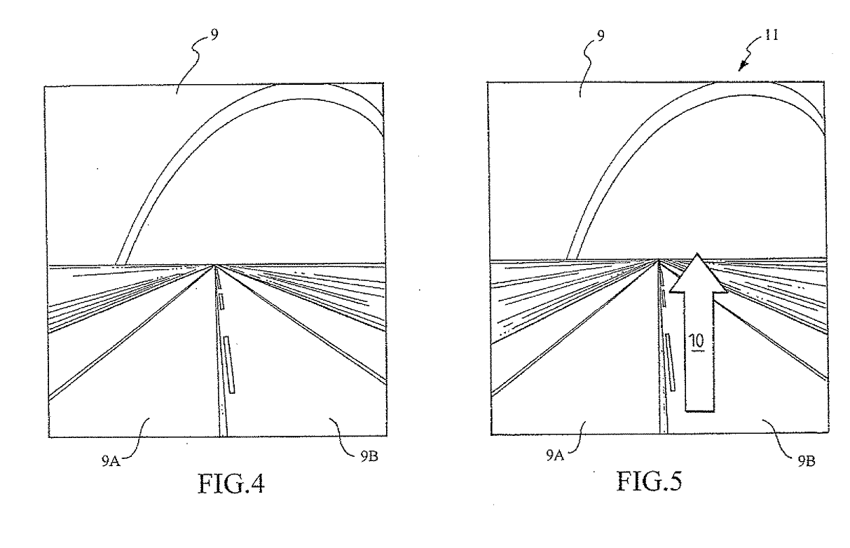

FIG. 4 shows a picture corresponding to a real scene 9 as captured by the digital camera 4, while FIG. 5 shows the real scene based driving information 11 as provided by the navigator system onto its display 6 according to the present invention, in particular comprising the driving direction indicator 10 in the form of a straight arrow superposed to the real scene 9. As previously explained, such straight arrow 10 has been calculated in step S7. It should be clear that more complex pictorials can be used and displayed, when needed.

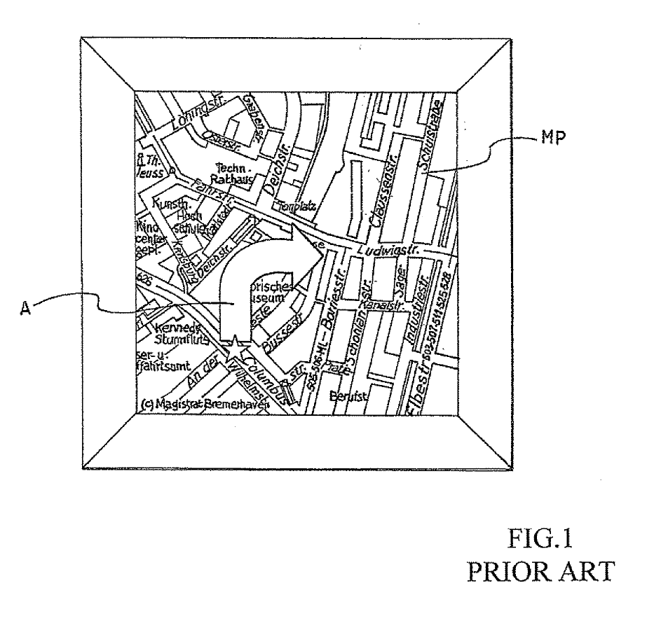

Through a comparison with the prior art display as shown in FIG. 1, it is possible to appreciate the simplicity and full understandability of the real scene based driving information 11 provided by the vehicle navigation system 1 according to the invention as compared to the traditional ones. Moreover, advantageously according to the invention, having the vehicle navigation system 1 already processed the road structure and thus recognized the lanes 9A and 9B, the displayed real scene based driving information 11 may be further improved by correctly positioning the driving direction indicator 10 onto line 9B, along which vehicle has to travel.

In other words, the detected lanes and lane limits in step S7 are used to center the driving direction indicator 10 as calculated by the of the vehicle navigation system 1 inside the picture as taken by the digital camera 4 and correctly show the real scene based driving information 11 on the display 6. The invention has the advantage of the use of a camera installed on the car in addition to the map information coming from a memory unit. The camera is preferably easy to install on the car. The method provides for combining the information from the map to the detection of the car motion. The system will output to a screen the correct direction to be taken so that it is much easier for the driver to understand the correct direction.

1-16. (canceled)

17. A vehicle navigation system comprising:
an antenna to receive navigation signals;
a controller to detect a global position of the vehicle based upon the navigation signals received by the antenna;
a memory cooperating with the controller and storing a navigation database including electronic maps;
a display cooperating with the controller to display guidance to the vehicle driver according to the global position of the vehicle computed with reference to the electronic maps; and
a camera carried by the vehicle to provide, on the display, an image of a view currently observable by a driver of the vehicle.

18. The system according to claim 17, wherein the camera comprises a digital camera.

19. The system according to claim 17, wherein the guidance includes at least one directional arrow.

20. The system according to claim 17, wherein the memory stores the image.

21. The system according to claim 20, wherein the controller refreshes the stored image periodically.

22. The system according to claim 19, wherein the controller determines lanes and lane limits within the image and cooperates with the display to display the at least one directional arrow within the lane limits.

23. The system according to claim 22, wherein the memory also stores pre-recorded digital pictures, and wherein the controller processes and compares the images provided by the camera with the prerecorded digital pictures in the memory and, based upon a discrepancy, replaces the pre-stored digital pictures with the images provided by the camera.

24. The system according to claim 22, wherein the controller processes and compares the images provided by the camera with the electronic maps stored in the navigation database and, based upon a discrepancy, updates the electronic maps of the navigation database with updated lanes and lane limits, and cooperates with the display to recalculate and display the at least one directional arrow within the updated lane limits.

25. The system according to claim 23, wherein the controller determines road traffic signs within the image and cooperates with the display to display the guidance based upon road traffic signs.

26. The system according to claim 17, wherein the antenna is to receive at least one of GPS and GNSS navigation signals.

27. The system according to claim 17, further comprising an audio output cooperating with the controller to provide at least a portion of the guidance as voice guidance information to the vehicle driver.

28. The system according to claim 17, further comprising a user interface to receive input from the vehicle driver.

29. A vehicle navigation system comprising:
a controller to detect a global position of the vehicle based upon received navigation signals;
a memory cooperating with the controller and storing a navigation database including electronic maps;
a display cooperating with the controller to display guidance to the vehicle driver according to a position of the vehicle computed with reference to the electronic maps, the guidance including at least one directional arrow; and
a digital camera to provide, on the display, an image of a view currently observable by a driver of the vehicle;
the controller determining lanes and lane limits within the image and cooperating with the display to display the at least one directional arrow within the lane limits.

30. The system according to claim 29, wherein the memory stores the image.

31. The system according to claim 30, wherein the controller refreshes the stored image periodically.

32. A navigation method for guiding a driver of a vehicle with a navigation system including an antenna, an associated controller, an associated memory, an associated display and an associated camera, the method comprising:
receiving navigation signals via the antenna and detecting a global position of the vehicle with the controller;
comparing the global position with road maps stored in the memory to define the road position of the vehicle with respect to the road maps;
capturing an image of a view observable by the vehicle driver with the camera; and
displaying the image on the display along with guidance for the vehicle driver according to the road position of the vehicle defined with reference to the road maps.

33. The method according to claim 32, wherein the camera comprises a digital camera for recording digital images.

34. The method according to claim 32, wherein the image is stored in the memory and refreshed periodically.

35. The method according to claim 32, wherein the guidance at least includes one directional arrow.

36. The method according to claim 35, wherein the controller determines lanes and lane limits within the images and displays the at least one directional arrow within the lane limits.

37. The method according to claim 32, wherein the memory also stores prerecorded digital pictures, and wherein the controller processes and compares the images provided by the camera with the pre-recorded digital pictures in the memory and, based upon a discrepancy, replaces the pre-stored digital pictures with the images provided by the camera.

38. The method according to claim 32, wherein the controller processes and compares the images provided by the camera with the electronic maps stored in the navigation database and, based upon a discrepancy, updates the electronic maps of the navigation database with updated lanes and lane limits, and cooperates with the display to recalculate and display the at least one directional arrow within the updated lane limits.

39. The method according to claim 32, wherein the controller determines road traffic signs within the image and cooperates with the display to display the guidance based upon road traffic signs.

40. The method according to claim 32, further comprising calibrating the camera based upon at least an image of the vehicle and a plrality of monitoring beacons at different distances.
